(19) United States
(12) Patent Application Publication
(10) Pub. No.: US 2016/0155351 A1
(43) Pub. Date: Jun. 2, 2016

(54) TASK KIT WITH TOOLS AND A MULTIMEDIA GUIDANCE FEATURE

(71) Applicant: Robert Thomas Coles, Matawan, NJ (US)

(72) Inventor: Robert Thomas Coles, Matawan, NJ (US)

(21) Appl. No.: 14/953,450

(22) Filed: Nov. 30, 2015

Related U.S. Application Data
(60) Provisional application No. 62/123,895, filed on Dec. 1, 2014.

(51) Int. Cl. G09B 19/00; G09B 1/02; G09B 5/02; F16B 1/00

(52) U.S. Cl. CPC G09B 19/00; F16B 1/00; G09B 1/02; G09B 5/02; F16B 2001/0035

(57) ABSTRACT

A task kit with tools and a multimedia guidance feature which includes a display device mounted in a support frame, wherein the display device is in communication with a source of multimedia content relating to performance of an identified task and one or more tools relating to the performance of the identified task and displayed on the display device.

### CROSS-REFERENCE TO RELATED APPLICATIONS

This application claims the benefit of U.S. Provisional Patent Application No. 62/123,895 which was filed Dec. 1, 2014, the disclosure of which is incorporated herein by reference.

### BACKGROUND OF THE INVENTION

1. Field of the Invention

This invention relates to a task kit, system and method for providing user-responsive step-by-step multimedia repair instructions with implements useful in the performance of one or more physical tasks by the user.

2. Description of the Related Art

Many assembly, repair and maintenance tasks can be performed by individuals of relative handiness without the need for hiring a professional. Detailed written instructions can make many such assembly, repair and maintenance tasks easier by breaking them down into steps, but often fail to sufficiently eliminate the difficulty as a whole of performing such tasks.

For example, it can be frustrating to attempt to perform each step in sequence while continuously referring to pages of a written instruction guide. Furthermore, there are often no instructions available for some tasks, such as repair and maintenance tasks.

Even with some guidance, these tasks can end up being excessively time-consuming and fail to ultimately be cost-effective, which may have been the reason for doing it yourself instead of contacting a professional, at least because many tasks require the selecting and/or purchasing of necessary implements, such as tools and parts.

Accordingly, it would be a significant benefit to provide a task kit which provides audio visual guidance and step-by-step instructions to perform a task with includes the necessary implements.

### SUMMARY OF THE INVENTION

The invention is generally directed to a kit, systems, methods and apparatus which, among other things, solves the needs in the art described above. The invention enables a user to receive the audio visual guidance needed to perform the necessary steps to complete a task with the particular implements.

Some embodiments of the invention are directed to a task kit having a body comprising an upper portion and a lower portion which are pivotally connected to one another and closeable to form a non-permanent engagement, wherein each of the upper and lower portions include a respective inner recess which cooperate to create a secure inner storage volume when the upper and lower portions are in the closed condition.

A display device, processing device, memory and data communication device, all of which may be contained in a unitary housing and connected through wires or wirelessly, are mounted in the inner recess of the upper portion. The display device may be a touchscreen device. The memory contains programming which can be executed by the processor to provide audio visual guidance and step-by-step instructions responsive to a user selection of a task made through the data communication device which may be enabled for voice-activation through an audio receiver, touch activation through a touchscreen device or activated by a data signal received from a separate depressible button in the inner recess of the upper or lower portion or from a remote device.

The inner recess of the lower portion includes a plurality of deformable sections defining cavities for creating a resistive but non-permanent engagement with implements such as tools and supplies to perform a selected task. Preferably, the deformable sections and/or implements are labelled to correspond with the audio visual step-by-step instructions selected.

For ease of operation the upper portion may be opened and secured by an upper portion prop mechanism to maintain the display in the inner recess of the upper portion in a comfortable viewing position for the user. The upper portion prop mechanism may be any conventional non-permanent mechanism, such as one or more rods or beams and corresponding receiving slots.

Once the task to be performed is selected, an audio visual presentation is provided by the display device to assist a user in performing the selected task with the implements stored in the lower portion of the body. The audio visual presentation continues providing detailed step-by-step information directing how to perform the selected task with the implements provided. The presentation may stop or start, repeat or play different segments responsive to continued user selections, some or all of which may be prompted by the presentation.

Some embodiments of the invention are directed to a task kit with tools and a multimedia guidance feature, comprising: a support frame; a display device mounted in the support frame, wherein the display device is in communication with a source of multimedia content relating to performance of an identified task; opposing legs pivotally connected to the support frame; and one or more tools relating to the performance of the identified task and displayed on the display device.

In some embodiments the support frame further comprises a closable case.

Some embodiments of the invention further include a hook retractably connected with the support frame.

Some embodiments of the invention further include a plurality of magnets mounted on the support frame in spaced positions relative to one another.

Some embodiments of the invention further include a receptacle for storing the tools, wherein the receptacle is connected to the support frame. In other embodiments, the support frame includes a non-permanent engagement member for securing the support frame to a tool box.

### BRIEF DESCRIPTION OF THE DRAWINGS

FIG. 1 is a front view of an exemplary kit constructed in accordance with some embodiments of the invention;

FIG. 2 is a side view of the kit shown in FIG. 1;

FIG. 3 is a side view of the kit shown in FIG. 1 with legs pivoted to support the kit in an upright position;

FIG. 4 is a closeup perspective view of a hook associated with the kit of FIG. 1 in the extended position for mounting the kit;

FIG. 5 is a closeup perspective view of a hook associated with the kit of FIG. 1 in the refracted position;

FIG. 6 is a closeup perspective view of a flexible utility light operatively associated with the kit of FIG. 1;

FIG. 7 is a front view of another exemplary kit constructed in accordance with some embodiments of the invention;

FIG. 8 is a side view of the kit shown in FIG. 7;

FIG. 9 is a side view of the kit shown in FIG. 7 with legs pivoted to support the kit in an upright position;

FIG. 10 is a closeup perspective view of a hook associated with the kit of FIG. 7 in the extended position for mounting the kit;

FIG. 11 is a closeup perspective view of a hook associated with the kit of FIG. 7 in the refracted position;

FIG. 12 is a closeup perspective view of a flexible utility light operatively associated with the kit of FIG. 7; and

FIG. 13 is a schematic diagram depicting the components of an exemplary system configured and constructed according to some embodiments of the invention, such as the kits described herein.

### DETAILED DESCRIPTION OF THE INVENTION

In the following description, numerous specific details are set forth in order to provide a more thorough description of the invention. In particular, the detailed description below provides an exemplary kit constructed according to the invention which is configured to enable various selectable tasks relating to automotive repair and maintenance.

It should be appreciated that the invention described and claimed herein could be applied to other tasks as well, such as for example, home repair, computer repair, motorcycle repair and maintenance and other do-it-yourself home or hobby projects not listed here. Thus, it will be apparent to one skilled in the art, that the invention may be practiced without at least some of the specific details provided herein. In other instances, well-known features have not been described in detail so as not to obscure the invention.

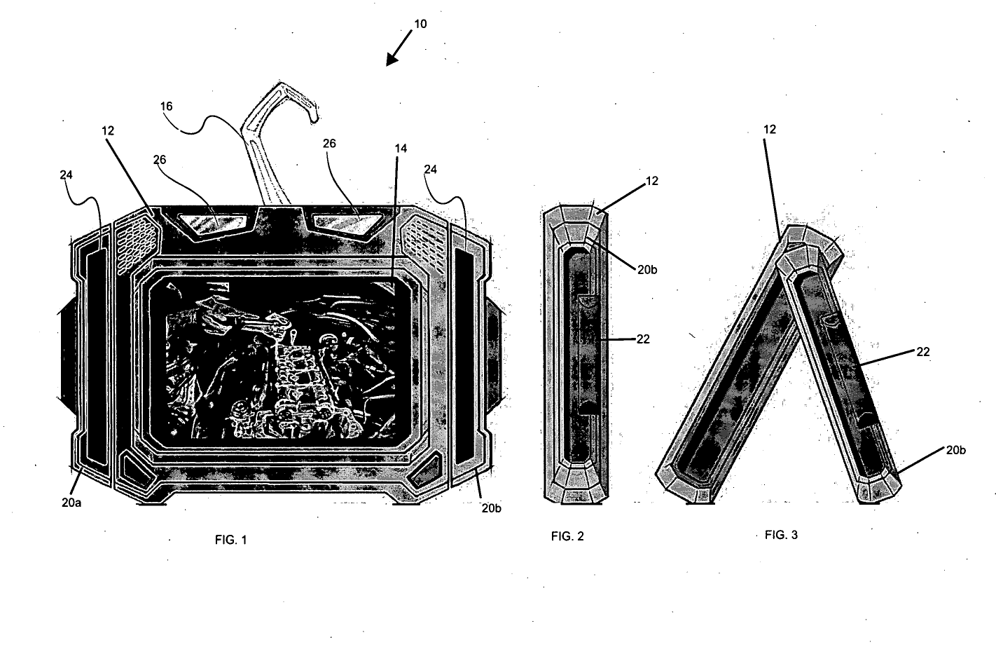

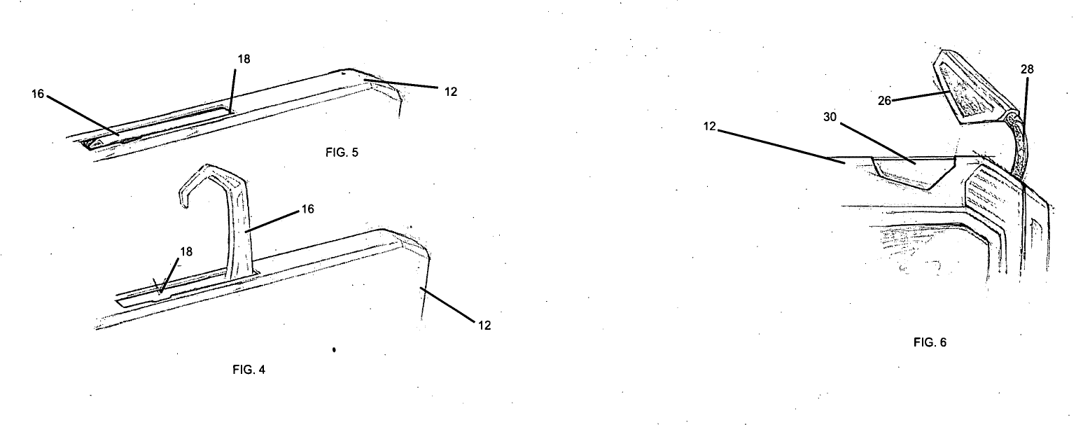

FIGS. 1-6 illustrate an embodiment of a kit constructed in accordance with the invention generally referred to by the reference numeral 10. Kit 10 includes a support structure or case 12 securing a display device 14 therein. Case 12 further includes mounting or positioning features such as a retractable hook 16 configured for retracting in and out of a hook receiving slot 18, and pivoting legs 20a and 20b. Pivoting legs 20a,b pivot to position case 12 such that display device 14 is readily visible. Each leg 20a and 20b includes a handle 22 and a magnet 24 mounted therein. Magnets 24 are sufficiently sized to securely mount case 12 to magnetically attractive materials, such as for example, in various locations underneath the hood of an automobile. Case 12 also includes lights 26 with at least one light 26 having a retractable goose neck 28 which is retractable in and out of a receiving slot 30 defined in case 12. Lights 26 may be LED lights.

It should be understood that case 12 may also include locations for tools and supplies therein, such as in the opposing side (not shown) of display device 14, or kit 10 may include another tool and supply storage component (not shown) connectable to or otherwise associated with case 12, wherein the tools and supplies are substantially same tools and supplies as shown in videos displayed by display device 14.

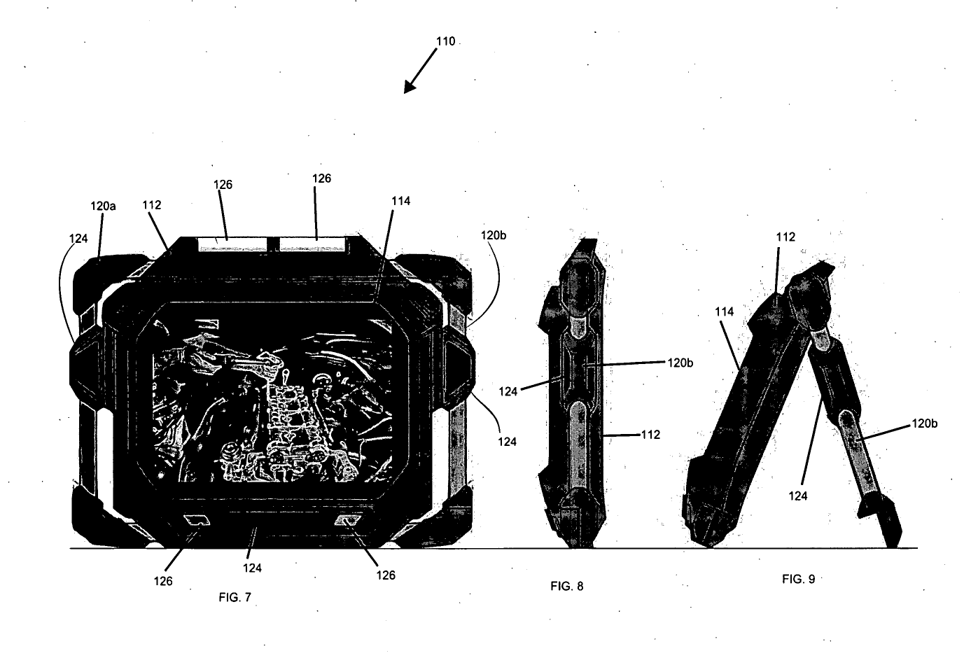

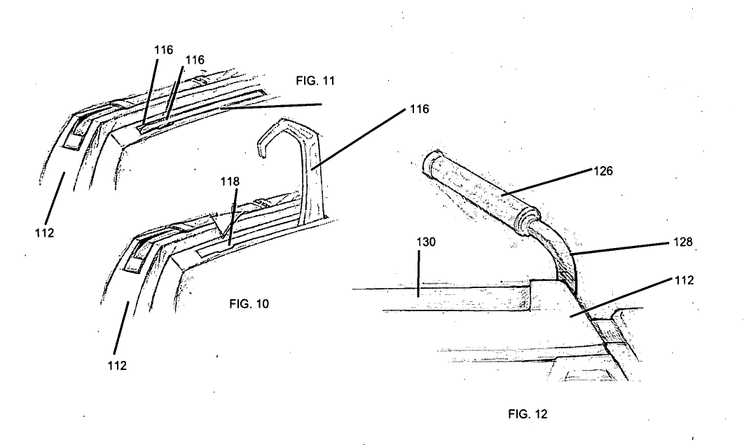

FIGS. 7-12 illustrate an embodiment of a kit constructed in accordance with the invention generally referred to by the reference numeral 110. Kit 110 includes a support structure or case 112 securing a display device 114 therein. Case 112 further includes mounting or positioning features such as a retractable hook 116 configured for retracting in and out of a hook receiving slot 118, and pivoting legs 120a and 120b. Pivoting legs 120a,b pivot to position case 112 such that display device 114 is readily visible. Each leg 120a and 120b includes a handle 122 and a magnet 124 mounted therein. Magnets 124 are sufficiently sized and spaced about case 112 to securely mount case 112 to magnetically attractive materials, such as for example, in various locations underneath the hood of an automobile. Case 112 also includes four lights 126 and at least one light 126 with a retractable goose neck 128 which is retractable in and out of a receiving slot 130 defined in case 112. Lights 126 may be LED lights.

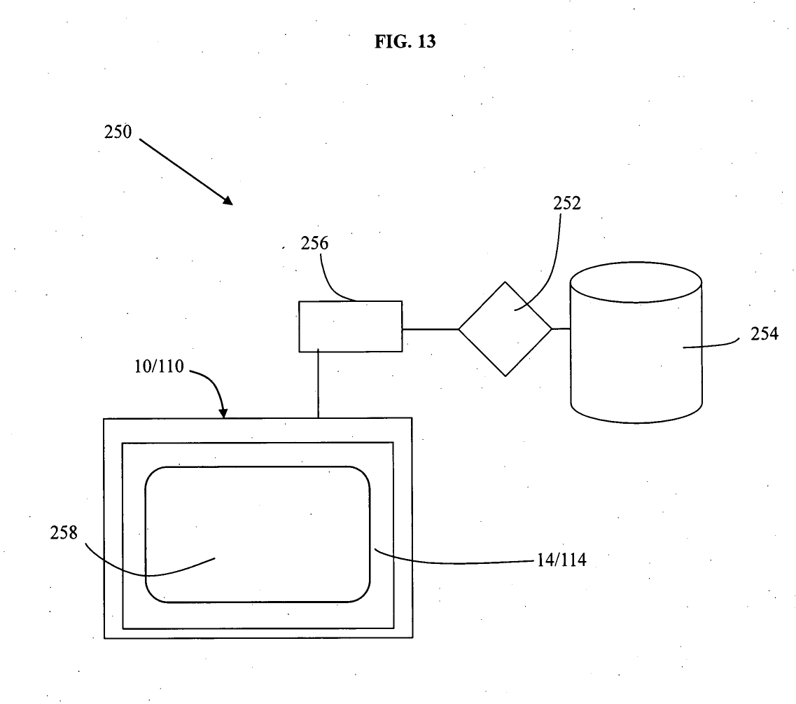

FIG. 13 illustrates an exemplary system 250 constructed in accordance with some embodiments of the invention to support kits described herein such as kits 10 and 110. System 250 includes processing device 252 in communication with a database or memory device 254, communication data input/output device 256 and a display device, such as display device 14 or 114. The display device, whether 14 or 114, may be a touch-enabled device or otherwise includes a data input/selection feature. Memory device 254 may include data relating to the display content 258 provided on the display device 14 or 114, including menu screens or videos either downloaded or installed for playing on the display device 14 or 114. Memory device 254 may also act as a buffer for streamlining video play received from contact with a wireless source such as the Internet through communication device 256. A power source, such as rechargeable battery (not shown), is connected with system 250 as well. It should be understood that system 250 may be installed within the body of the display device 14 or 114 of the invention.

Using kit 10 as an example, in operation a user can position case 12 as desired using hook 16, legs 20a,b and/or magnets 22. Case 12 may therefore be positioned in the most convenient location for viewing, following the instructions displayed on display device 14 and using tools accordingly after selecting the video to play through communication device 256. Processing device 252 may ensure administrative protocols and requirements are followed, such as the user being logged in and having sufficient credit or payment for the video to be displayed on the display device. A user may play, pause or replay the video as desired using the display device 14 if touchscreen or through another control device which may be remote. The videos displayed will provide multimedia instructions for carrying out a task which the user can follow by using the tools and supplies which may be provided with kit 10. Users may access additional content such as videos by accessing the world wide web or Internet through communication device 256.

Exemplary kits constructed in accordance with the invention can include permanent or non-permanent engagements or fastening mechanisms, such as nuts and bolts, latches, screws, magnets (such as magnets 24 or 124) and/or interlocking engagement members, which allow for the case, such as case 12 or 112, to be secured to the surface of a tool box having storage for tools and supplies therein that are associated with content displayed on a display device relating to a specific task. For example, the case may be secured to the outside or inside lid of a tool box. In embodiments where the engagement with a tool box is non-permanent, the case of the invention, such as case 12 or 112, may be alternatively secured to and removed from a plurality of tool boxes designed for various tasks and associated content may be available. The tool boxes may include or otherwise be sold with a DVD, memory stick or other non-transitory computer readable medium, or code to use on a website for purposes of downloading content. Thus, in such embodiments, a user may load or download content for display on the display device of the kit of the invention relating to a particular task. The case of the invention may be secured to the tool box for convenience sake and the user would watch the display while using the tools and supplies in the tool box to perform the task. The user can then purchase another tool box for a different task using the same kit of the invention.

Exemplary kits constructed in accordance with embodiments of the invention may include data storage devices or databases, control programs, data processors, and communication devices for receiving and transmitting data. However, it is expected that one of ordinary skill, notwithstanding the many design choices motivated by, for example, available time, current technology, and economic considerations, when guided by the concepts and principles disclosed herein will be readily capable of generating software and selecting appropriate hardware with minimal experimentation. Therefore, in the interest of brevity and minimization of any risk of obscuring the principles and concepts according to this embodiment of the invention, further discussion of such software and hardware, if any, will be limited to the essentials with respect to the principles and concepts used by the exemplary embodiments discussed herein.

Those skilled in the art will readily appreciate that a kit constructed in accordance with some embodiments of the invention may include various computer and network related software and hardware, that is, programs, operating systems, memory storage devices, data input/output devices, data processors, servers with links to data communication systems, wireless or otherwise, such as the world wide web or a local or wide area network.

Those skilled in the art will further appreciate that the particular types of communication network and devices, software and hardware are not vital to the full implementation of the embodiments described herein or other embodiments within the scope and spirit of the invention. Although the description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways. Furthermore, well known process steps and computer components may have not been described in detail herein in order to avoid unnecessarily obscuring the underlying concepts.

It should be further understood that the type of communication network and devices, software and hardware may also vary and the precise software and hardware configuration of the various embodiments of the invention may vary accordingly while still remaining within the scope and spirit of the invention. With the continuous and ongoing improvements in computer and electronic technology, many modifications may be made to the specific nature of hardware and/or software components required. Accordingly, one of skill in the art may select any hardware components that would rapidly and efficiently process the data and provide storage and communication as needed for the successful operation of some embodiments of the invention.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor or processing device, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

While exemplary systems and methods, and applications of methods of the invention, have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth in the claims and equivalents thereto.

1. A task kit with tools and a multimedia guidance feature, comprising:
a) a support frame;
b) a display device mounted in the support frame, wherein the display device is in communication with a source of multimedia content relating to performance of an identified task;
c) opposing legs pivotally connected to the support frame; and
d) one or more tools relating to the performance of the identified task and displayed on the display device.

2. A task kit as recited in claim 1, wherein the support frame further comprises a closable case.

3. A task kit as recited in claim 1, further comprising a hook retractably connected with the support frame.

4. A task kit as recited in claim 1, further comprising a plurality of magnets mounted on the support frame.

5. A task kit as recited in claim 1, further comprising a receptacle for storing the tools, wherein the receptacle is connected to the support frame.

6. A task kit as recited in claim 1, wherein the support frame includes a non-permanent engagement member for securing the support frame to a tool box.
